(19) United States
(12) Patent Application Publication
(10) Pub. No.: US 2017/0275183 A1
(43) Pub. Date: Sep. 28, 2017

(54) METHOD FOR REMOVING CARBON DIOXIDE FROM OCEAN WATER AND QUANTIFYING THE CARBON DIOXIDE SO REMOVED

(71) Applicant: LiveFuels, Inc., Menlo Park, CA (US)

(72) Inventors: Gaye Elizabeth Morganthaler, Woodside, CA (US); David Vancott Jones, Woodside, CA (US)

(21) Appl. No.: 15/289,046

(22) Filed: Oct. 7, 2016

Related U.S. Application Data
(63) Continuation of application No. 13/463,625, filed on May 3, 2012, now abandoned.
(60) Provisional application No. 61/483,316, filed on May 6, 2011.

(51) Int. Cl. C02F 1/20; A01K 61/00; C02F 3/00; C02F 3/32; C02F 101/10; C02F 103/08

(52) U.S. Cl. CPC C02F 1/20; C02F 3/32; A01K 61/00; C02F 3/006; C02F 2101/10; C02F 2103/08; C02F 2209/02; C02F 2209/05; C02F 2209/06; C02F 2209/07; C02F 2209/11; C02F 2209/18; C02F 2209/22; C02F 2209/16; Y02W 10/37

(57) ABSTRACT

Disclosed herein are methods and systems for removing carbon dioxide (CO₂) from water and quantifying the carbon so removed, thus facilitating valuation of that carbon for schemes (e.g., Kyoto agreement) that attach financial rewards for capture, sequestration or removal of carbon or CO₂.

### CROSS-REFERENCE TO RELATED APPLICATIONS

This application claims priority to U.S. Provisional Patent Application No. 61/483,316, filed May 6, 2011, which provisional application is incorporated herein by reference in its entirety. All patents and patent applications cited in this application, all related applications referenced herein, and all references cited therein are incorporated herein by reference in their entirety as if restated here in full and as if each individual patent and patent application was specifically and individually indicated to be incorporated by reference.

### FIELD OF THE INVENTION

The present invention provides methods and systems for removing carbon dioxide (CO₂) from water and quantifying the carbon so removed, thus facilitating valuation of that carbon for schemes (e.g., Kyoto agreement) that attach financial rewards for capture, sequestration or removal of carbon or CO₂.

### BACKGROUND OF THE INVENTION

Empirical research shows that atmospheric carbon dioxide (CO₂) has risen at an accelerated rate starting approximately 200 years ago. Because of this increase and because the earth's oceans absorb gasses from the atmosphere, a greater amount of CO₂ is dissolving into the world's oceans. The Intergovernmental Panel on Climate Change estimates that by the end of this century, rising oceanic CO₂ could change ocean chemistry more rapidly and drastically than any time over the last 20 million years, and lead to devastating effects on marine life.

Dissolved ocean CO₂ reduces availability of carbonate ions (CO₃²⁻) as shown by the following:

Dissolved CO₂ reacts with water to form carbonic acid:

CO₂+H₂O→H₂CO₃

The carbonic acid dissociates, thereby releasing hydrogen ions and bicarbonate into the water:

H₂CO₃→H⁺+HCO₃⁻

The hydrogen ions combine with any available carbonate ions to form additional bicarbonate:

H⁺+CO₃²⁻→HCO₃⁻

Carbonate ions are critically important building blocks for corals, mollusks and other invertebrates, but these organisms cannot use bicarbonate in the same manner. The presence of CO₂ in water converts carbonate ions into molecules of bicarbonate, and this reaction is occurring more frequently as CO₂ levels rise, leading to a reduction in carbonate ions and affecting many marine species. Thus it will be advantageous to develop methods for removing CO₂ from the oceans.

Carbon dioxide can be captured by plants including most species of microalgae through the well-known process of photosynthesis. The photosynthetic process uses light energy (e.g., sunlight) to convert CO₂ into sugars and other molecules useful to plants. This reaction forms the basis for virtually all life on this planet, either directly as just described or indirectly as higher or other “trophic level” organisms consume plant matter. Thus essentially all life forms contain predominately “biomass carbon” that was previously CO₂, either atmospheric or dissolved in water.

A substantial amount of oceanic biomass carbon ultimately precipitates out of the upper levels of the ocean and descends into the depths. A portion of this is bioavailable carbon that has escaped consumption by scavenging organisms. A substantially greater amount is believed to be bio-unavailable carbon fixed by various recently-discovered microbes (see Jiao et al., 2010, “Microbial production of recalcitrant dissolved organic matter: long-term carbon storage in the global ocean,” Nature Reviews Microbiology 8, 593-599).

Various methods have been proposed to remove biomass carbon or CO₂ from seawater. A group of techniques describes ways to react CO₂-containing seawater to form stable precipitates that can be removed and may have further commercial application (see U.S. Pat. No. 7,887,694 and references disclosed therein). This is currently undergoing commercialization efforts but appears to be limited by proximity to various inputs (e.g., CO₂ sourced from an ocean-side power plant). Another class of inventions proposes to artificially alter ocean chemistry by adding nitrogen or other minerals (see, e.g., U.S. Pat. Nos. 6,056,919 and 5,992,089) to encourage a large increase in microalgae production. Experimental efforts to implement these methods reveal challenges such as encouraging growth of harmful algae and creation of excess methane as the algae biodegrades (methane having greater impact than CO₂ as a greenhouse gas). Harvesting algae directly is prohibitively expensive. Algae naturally grows at a density of approximately 300 parts per million, so must be separated from a very large quantity of water. Removing this water by centrifuge and drying to achieve approximately 15% moisture content is estimated to consume 150% of the energy in the algae, thus unacceptably inefficient.

Accordingly, a need exists for an approach to capture CO₂ via algae in a cost-effective manner, and thus delay or neutralize the effects of changing ocean chemistry.

### SUMMARY OF THE INVENTION

In one aspect, the present invention provides a method for removing carbon dioxide from water, and optionally quantifying the amount of carbon dioxide so removed.

In certain embodiments, the method for removing carbon dioxide from water comprises: (i) harvesting algae by fish that feed on the algae; and (ii) processing fish into useful products. In certain embodiments, the fish harvest the algae in an aquatic environment. In certain embodiments, the useful products are fish oils or fishmeal. In certain embodiments, the aquatic environment is controlled by monitoring and/or adjusting an aquatic variable selected from the group consisting of pH, salinity, dissolved oxygen, alkalinity, nutrient concentrations, water homogeneity, temperature, turbidity, algae culture, and fish stock. In certain embodiments, the aquatic variables are adjusted to optimize removal of the carbon dioxide from the water.

In certain embodiments, the method for removing carbon dioxide from water comprises: (i) feeding algae to a population of fish in a water-containing enclosure; and (ii) gathering the fish from the enclosure, and extracting oil and fishmeal from the fish. In certain embodiments, the method further comprises assigning tradable credits to the carbon dioxide removed from the water.

In certain embodiments, the method for removing carbon dioxide from water comprises: (i) converting the carbon dioxide in the water into algal biomass carbon; and (ii) converting the algal biomass carbon into fish biomass carbon. In certain embodiments, the method further comprises measurement of a feed conversion ratio. In certain embodiments, the feed conversion ratio is maintained within a range that optimizes carbon dioxide removal from the water. In certain embodiments, the method further comprises quantifying the fish biomass carbon. In certain embodiments, the amount of fish biomass quantified is used to quantify the amount of carbon dioxide removed from the water. In certain embodiments, the method further comprises assigning tradable credits to the carbon dioxide removed from the water, wherein the credits may be traded in established, proposed, or envisioned carbon credit trading programs such as those established under the Kyoto protocol.

In another aspect, the present invention provides a system for removing carbon dioxide from water.

In certain embodiments, the system for removing carbon dioxide from water comprises: (i) a means for harvesting algae by fish that feed on the algae; and (ii) a means for processing fish into useful products. In certain embodiments, the system further comprises a means for connecting (i) and (ii). In certain embodiments, the system is controlled. In certain embodiments, the means for harvesting algae comprises growth enclosure(s) and/or fish enclosure(s), wherein the enclosure(s) can each be closed or open, or a combination of open and closed enclosures. In certain embodiments, communication or material flow between a closed enclosure and its immediate aquatic and/or atmospheric environment is highly controlled relative to an open enclosure.

In another aspect, the present invention provides a method of optimizing removal of carbon dioxide from water.

In certain embodiments, the method of optimizing removal of carbon dioxide from water comprises: (i) converting the carbon dioxide in the water into algal biomass carbon; (ii) converting the algal biomass carbon into fish biomass carbon; and (iii) quantifying the fish biomass carbon of step (ii). In certain embodiments, the method further comprises using the amount of fish biomass quantified in step (iii) to quantify the amount of carbon dioxide removed from the water. In certain embodiments, steps (i) and (ii) take place in an aquatic environment. In certain embodiments, the amount of fish biomass carbon quantified is used to calculate carbon credits for trading in established carbon credit trading programs such as those established under the Kyoto protocol. In certain embodiments, tradable carbon credits above a certain allowance indicate that the amount of carbon dioxide removed from the water may be decreased, and tradable carbon credits below a certain allowance indicate that the amount of carbon dioxide removed from the water may be increased. In certain embodiments, the amount of carbon dioxide removed from the water may be increased or decreased by controlling the aquatic environment. In certain embodiments, the aquatic environment is controlled by monitoring and/or adjusting an aquatic variable selected from the group consisting of pH, salinity, dissolved oxygen, alkalinity, nutrient concentrations, water homogeneity, temperature, turbidity, algae culture, and fish stock.

In another aspect, the present invention provides a method of creating tradable carbon credits for trading in established carbon credit trading programs such as those established under the Kyoto protocol.

In certain embodiments, the method of creating tradable carbon credits comprises: (i) removing carbon dioxide from water; (ii) producing biomass carbon from the carbon dioxide under conditions such that carbon credits are generated; and (iii) transferring the resulting carbon credits to a third party. In certain embodiments, the method further comprises quantifying the biomass carbon produced from the carbon dioxide to calculate the carbon credits. In certain embodiments, the biomass carbon is produced by harvesting algae by fish that feed on the algae.

### DETAILED DESCRIPTION OF THE INVENTION

The present invention provides methods and systems to capture or remove CO₂ from water via algae in a cost-effective manner. The methods of the invention use fish to harvest algae and thus capture carbon in the biomass of the fish. Once thus captured, the fish biomass can be converted to several useful products like fish oils (lipids) and fishmeal (mostly protein), or used to generate carbon credits for trading.

The inventors take advantage of the trophic system and capture the CO₂ (in the form of organic carbon) from organisms in a higher trophic level. The invention primarily uses fish that are at a higher trophic level to harvest the algae. The energy cost expended in processing fish is more favorable than directly processing algae. For example, adult menhaden (average 1 lb in weight) are estimated to filter phytoplankton from seawater continuously at a rate of 7 gallons per minute with minimal energy expenditure (Peck, 1893, “On the food of the menhaden,” Bull. U.S. Fish. Comm. 13: 113-126). In fact, base energy expenditure of fish is typically 10-30 times lower than in mammals because of ectothermy, ammonotelism, and buoyancy (Guillaume et al., Nutrition and Feeding of Fish and Crustaceans. Springer Publishing, 2001).

Autotrophic algae grow under sunlight and the solar energy is captured by photosynthesis in the biomass of algae. Instead of harvesting the algae and the carbon contained in the algae, the invention methods employ fish that feed on the algae to harvest the carbon. Algae occupy one of the lowest trophic levels in most aquatic ecological systems. By consuming the algae, the fish at a higher trophic level (e.g., trophic level 2) convert the algal biomass carbon into fish biomass carbon. Because the fish obtain essentially all of their energy from the algae, little to no additional energy need be added to the system in order to harvest the algae. Many fish, at a higher trophic level than algae, feed on algae as well as zooplanktons and/or detritus, thereby recovering the energy and biomass present in detritus or lost to zooplanktons that graze on algae. Carnivorous fish (e.g., at trophic level 3) can also be used in the system to harvest the fish of a lower trophic level, such as the herbivorous, planktivorous, and detritivorus fish.

The methods of the invention generally comprise feeding algae to a population of fish in an aquatic environment of, for example, a water-containing enclosure, gathering the fish from the enclosure, and extracting oil and fishmeal from the fish. As described in details below, the algal culture can comprise a population of algae of one or more species, and the population of fish can comprise a single species of fish or multiple species. The term “algal composition” refers to any composition that comprises algae and is not limited to the culture in which the algae are cultivated. It is contemplated that an algal composition can be prepared by mixing different algae from a plurality of algal cultures. In various embodiments, the algae are cultivated and are present in an algal culture.

The methods of the invention may also comprise measurement with reasonable accuracy the amount of CO₂ represented by the fish biomass. In general terms, fish biomass (including fish oil and fishmeal) is approximately 50% carbon by dry weight (the balance being mostly oxygen with lesser amounts of nitrogen, phosphorus, potassium and dozens of other elements). It is also known that CO₂ is approximately 27% carbon by weight (CO₂=one molecule of carbon with atomic weight of 12 plus two molecules of oxygen each with atomic weight of 16; the carbon fraction is 12/(12+16+16)=27.27% of the total weight of the CO₂). Thus one mass unit of dry biomass contains the carbon found in 1.83 units of CO₂ (1.83=0.5/0.27). Accordingly, if one unit of biomass is removed from a system, such as the ocean, and no carbon other than CO₂ has been added to that system, it can be asserted that such removal is the equivalent of removing 1.83 carbon units (i.e., 0.5 units of CO₂) from that system.

The methods of the invention may further comprise creating tradable carbon credits based on the CO₂ removed from the water, wherein the credits may be traded in established carbon credit trading programs such as those established under the Kyoto Protocol to the United Nations Framework Convention on Climate Change (Kyoto protocol).

The algae and the fish that are used in the methods of the invention are described in Sections 4.1 and 4.2, respectively. As used herein the term “system” refers to the installations for practicing the methods of the invention. The methods and systems of the invention are described in Section 4.3.

The creation or assignment of tradable carbon credits based on the CO₂ removed from the water is described in Section 4.4.

Methods for optimizing the removal of CO₂ from the water are described in Section 4.5.

### 4.1 Algae

As used herein the term “algae” refers to any organisms with chlorophyll and a thallus not differentiated into roots, stems and leaves, and encompasses prokaryotic and eukaryotic organisms that are photoautotrophic or photoauxotrophic. The term “algae” includes macroalgae (commonly known as seaweed) and microalgae. For certain embodiments of the invention, algae that are not macroalgae are preferred. The terms “microalgae” and “phytoplankton,” used interchangeably herein, refer to any microscopic algae, photoautotrophic or photoauxotrophic eukaryotes (such as, protozoa), photoautotrophic or photoauxotrophic prokaryotes, and cyanobacteria (commonly referred to as blue-green algae and formerly classified as Cyanophyceae). The use of the term “algal” also relates to microalgae and thus encompasses the meaning of “microalgal.” The term “algal composition” refers to any composition that comprises algae, such as an aquatic composition, and is not limited to the body of water or the culture in which the algae are cultivated. An algal composition can be an algal culture, a concentrated algal culture, or a dewatered mass of algae, and can be in a liquid, semi-solid, or solid form. A non-liquid algal composition can be described in terms of moisture level or percentage weight of the solids. An “algal culture” is an algal composition that comprises live algae.

The microalgae of the invention are also encompassed by the term “plankton” which includes phytoplankton, zooplankton and bacterioplankton. For certain embodiments of the invention, an algal composition or a body of water comprising algae that is substantially depleted of zooplankton is preferred since many zooplankton consume phytoplankton. However, it is contemplated that many aspects of the invention can be practiced with a planktonic composition, without isolation of the phytoplankton, or removal of the zooplankton or other non-algal planktonic organisms. The methods of the invention can be used with a composition comprising plankton, or a body of water comprising plankton.

The algae of the invention can be a naturally occurring species, a genetically selected strain, a genetically manipulated strain, a transgenic strain, or a synthetic algae. Preferably, the algae bears at least a beneficial trait, such as but not limited to, increased growth rate, lipid accumulation, favorable lipid composition, adaptation to the culture environment, and robustness in changing environmental conditions. It is desirable that the algae accumulate excess lipids and/or hydrocarbons. However, this is not a requirement because the algal biomass, without excess lipids, can be converted to lipids metabolically by the harvesting fish. The algae in an algal composition of the invention may not all be cultivable under laboratory conditions. It is not required that all the algae in an algal composition of the invention be taxonomically classified or characterized in order to for the composition be used in the present invention. Algal compositions, including algal cultures, can be distinguished by the relative proportions of taxonomic groups that are present.

The algae of the invention use light as its energy source. The algae can be grown under the sunlight or artificial light. In addition to using mass per unit volume (such as mg/l or g/l), chlorophyll a is a commonly used indicator of algal biomass. However, it is subjected to variability of cellular chlorophyll content (0.1 to 9.7% of fresh algal weight) depending on algal species. An estimated biomass value can be calibrated based on the chlorophyll content of the dominant species within a population. Published correlation of chlorophyll a concentration and biomass value can be used in the invention. Generally, chlorophyll a concentration is to be measured within the euphotic zone of a body of water. The euphotic zone is the depth at which the light intensity of the photosynthetically active spectrum (400-700 nm) exceeds 1% of the surface light intensity.

Depending on the latitude of a site, algae obtained from tropical, subtropical, temperate, polar or other climatic regions are used in the invention. Endemic or indigenous algal species are generally preferred over introduced species where an open culturing system is used. Endemic or indigenous algae may be enriched or isolated from local water samples obtained at or near the site of the system. It is advantageous to use algae and fish from a local aquatic trophic system in the methods of the invention. Algae, including microalgae, inhabit many types of aquatic environment, including but not limited to freshwater (less than about 0.5 parts per thousand (ppt) salts), brackish (about 0.5 to about 31 ppt salts), marine (about 31 to about 38 ppt salts), and briny (greater than about 38 ppt salts) environment. Any of such aquatic environments, freshwater species, marine species, and/or species that thrive in varying and/or intermediate salinities or nutrient levels, can be used in the invention. The algae in an algal composition of the invention can be obtained initially from environmental samples of natural or man-made environments, and may contain a mixture of prokaryotic and eukaryotic organisms, wherein some of the species may be unidentified. Freshwater filtrates from rivers, lakes; seawater filtrates from coastal areas, oceans; water in hot springs or thermal vents; and lake, marine, or estuarine sediments, can be used to source the algae. The samples may also be collected from local or remote bodies of water, including surface as well as subterranean water.

One or more species of algae are present in the algal composition of the invention. In one embodiment of the invention, the algal composition is a monoculture, wherein only one species of algae is grown. However, in many open culturing systems, it may be difficult to avoid the presence of other algae species in the water. The inventors believe that an algae consortium can be more productive and healthier than a monoculture. Accordingly, a monoculture may comprise about 0.1% to 2% cells of algae species other than the intended species, i.e., up to 98% to 99.9% of the algal cells in a monoculture are of one species. In certain embodiments, the algal composition comprise an isolated species of algae, such as an axenic culture. In another embodiment, the algal composition is a mixed culture that comprises more than one species of algae, i.e., the algal culture is not a monoculture. Such a culture can be prepared by mixing different algal cultures or axenic cultures. In certain embodiments, the algal composition can also comprise zooplankton, bacterioplankton, and/or other planktonic organisms. In certain embodiments, an algal composition comprising a combination of different batches of algal cultures is used in the invention. The algal composition can be prepared by mixing a plurality of different algal cultures. The different taxonomic groups of algae can be present in defined proportions. The combination and proportion of different algae in an algal composition can be designed or adjusted to enhance the growth and/or accumulation of lipids of certain groups or species of fish. A microalgal composition of the invention can comprise predominantly microalgae of a selected size range, such as but not limited to, below 2000 μm, about 200 to 2000 μm, above 200 μm, below 200 μm, about 20 to 2000 μm, about 20 to 200 μm, above 20 μm, below 20 μm, about 2 to 20 μm, about 2 to 200 μm, about 2 to 2000 μm, below 2 μm, about 0.2 to 20 μm, about 0.2 to 2 μm or below 0.2 μm.

A mixed algal composition of the invention comprises one or several dominant species of macroalgae and/or microalgac. Microalgal species can be identified by microscopy and enumerated by counting visually or optically, or by techniques such as but not limited to microfluidics and flow cytometry, which are well known in the art. A dominant species is one that ranks high in the number of algal cells, e.g., the top one to five species with the highest number of cells relative to other species. Microalgae occur in unicellular, filamentous, or colonial forms. The number of algal cells can be estimated by counting the number of colonies or filaments. Alternatively, the dominant species can be determined by ranking the number of cells, colonies and/or filaments. This scheme of counting may be preferred in mixed cultures where different forms are present and the number of cells in a colony or filament is difficult to discern. In a mixed algal composition, the one or several dominant algae species may constitute greater than about 10%, about 20%, about 30%, about 40%, about 50%, about 60%, about 70%, about 80%, about 90%, about 95%, about 97%, about 98% of the algae present in the culture. In certain mixed algal composition, several dominant algae species may each independently constitute greater than about 10%, about 20%, about 30%, about 40%, about 50%, about 60%, about 70%, about 80% or about 90% of the algae present in the culture. Many other minor species of algae may also be present in such composition but they may constitute in aggregate less than about 50%, about 40%, about 30%, about 20%, about 10%, or about 5% of the algae present. In various embodiments, one, two, three, four, or five dominant species of algae are present in an algal composition. Accordingly, a mixed algal culture or an algal composition can be described and distinguished from other cultures or compositions by the dominant species of algae present. An algal composition can be further described by the percentages of cells that are of dominant species relative to minor species, or the percentages of each of the dominant species. The identification of dominant species can also be limited to species within a certain size class, e.g., below 2000 μm, about 200 to 2000 μm, above 200 μm, below 200 μm, about 20 to 2000 μm, about 20 to 200 μm, above 20 μm, below 20 μm, about 2 to 20 μm, about 2 to 200 μm, about 2 to 2000 μm, below 2 μm, about 0.2 to 20 μm, about 0.2 to 2 μm or below 0.2 μm. It is to be understood that mixed algal cultures or compositions having the same genus or species of algae may be different by virtue of the relative abundance of the various genus and/or species that are present.

It is contemplated that many different algal cultures or bodies of water that comprise plankton, can be harvested efficiently by the methods of the invention. Microalgae are preferably used in many embodiments of the invention; while macroalgae are less preferred in certain embodiments. In specific embodiments, algae of a particular taxonomic group, e.g., a particular genera or species, may be less preferred in a culture. Such algae, including one or more that are listed below, may be specifically excluded as a dominant species in a culture or composition. However, it should also be understood that in certain embodiments, such algae may be present as a contaminant, a non-dominant group or a minor species, especially in an open system. Such algae may be present in negligent numbers, or substantially diluted given the volume of the culture or composition. The presence of such algal genus or species in a culture, composition or a body of water is distinguishable from cultures, composition or bodies of water where such algal genus or species are dominant, or constitute the bulk of the algae. The composition of an algal culture or a body of water in an open culturing system is expected to change according to the four seasons, for example, the dominant species in one season may not be dominant in another season. An algal culture at a particular geographic location or a range of latitudes can therefore be more specifically described by season, i.e., spring composition, summer composition, fall composition, and winter composition; or by any one or more calendar months, such as but not limited to, from about December to about February, or from about May to about September. The species composition of an algal culture or a body of water in an open culturing system can also be modified by changing the chemical composition of the water, including but not limited to, nutrient concentrations (N/P/Si), pH, alkalinity, and salinity. The degree of mixing in the pond can also used to control the algae consortium. Given the remarkable specialization of algae species to environmental conditions, the dominant species can vary diurnally, seasonally, and even within a pond.

In various embodiments, one or more species of algae belonging to the following phyla can be harvested by the systems and methods of the invention: Cyanobacteria, Cyanophyta, Prochlorophyta, Rhodophyta, Glaucophyta, Chlorophyta, Dinophyta, Cryptophyta, Chrysophyta, Prymnesiophyta (Haptophyta), Bacillariophyta, Xanthophyta, Eustigmatophyta, Rhaphidophyta, and Phaeophyta. In certain embodiments, algae in multicellular or filamentous forms, such as seaweeds and/or macroalgae, many of which belong to the phyla Phaeophyta or Rhodophyta, are less preferred.

In certain embodiments, the algal composition of the invention comprises cyanobacteria (also known as blue-green algae) from one or more of the following taxonomic groups: Chroococcales, Nostocales, Oscillatoriales, Pseudanabaenales, Synechococcales, and Synechococcophycideae. Non-limiting examples include Gleocapsa, Pseudoanabaena, Oscillatoria, Microcystis, Synechococcus and Arthrospira species.

In certain embodiments, the algal composition of the invention comprises algae from one or more of the following taxonomic classes: Euglenophyceae, Dinophyceae, and Ebriophyceae. Non-limiting examples include Euglena species and the freshwater or marine dinoflagellates.

In certain embodiments, the algal composition of the invention comprises green algae from one or more of the following taxonomic classes: Micromonadophyceae, Charophyceae, Ulvophyceae and Chlorophyceae. Non-limiting examples include species of Borodinella, Chlorella (e.g., C. ellipsoidea), Chlamydomonas, Dunaliella (e.g., D. salina, D. bardawil), Franceia, Haematococcus, Oocystis (e.g., O. parva, O. pustilla), Scenedesmus, Stichococcus, Ankistrodesmus (e.g., A. falcatus), Chlorococcum, Monoraphidium, Nannochloris and Botryococcus (e.g., B. braunii). In certain embodiments, Chlamydomonas reinhardtii are less preferred.

In certain embodiments, the algal composition of the invention comprises golden-brown algae from one or more of the following taxonomic classes: Chrysophyceae and Synurophyceae. Non-limiting examples include Boekelovia species (e.g., B. hooglandii) and Ochromonas species.

In certain embodiments, the algal composition in the invention comprises freshwater, brackish, or marine diatoms from one or more of the following taxonomic classes: Bacillariophyceae, Coscinodiscophyceae, and Fragilariophyceae. Preferably, the diatoms are photoautotrophic or auxotrophic. Non-limiting examples include Achnanthes (e.g., A. orientalis), Amphora (e.g., A. coffeiformis strains, A. delicatissima), Amphiprora (e.g., A. hyaline), Amphipleura, Chaetoceros (e.g., C. muelleri, C. gracilis), Caloneis, Camphylodiscus, Cyclotella (e.g., C. cryptica, C. meneghiniana), Cricosphaera, Cymbella, Diploneis, Entomoneis, Fragilaria, Hantschia, Gyrosigma, Melosira, Navicula (e.g., N. acceptata, N. biskanterae, N. pseudotenelloides, N saprophila), Nitzschia (e.g., N dissipata, N communis, N inconspicua, N. pusilla strains, N. microcephala, N. intermedia, N hantzschiana, N alexandrina, N. quadrangula), Phaeodactylum (e.g., P. tricornutum), Pleurosigma, Pleurochrysis (e.g., P. carterae, P. dentata), Selenastrum, Surirella and Thalassiosira (e.g., T weissflogii).

In certain embodiments, the algal composition of the invention comprises planktons including microalgae that are characteristically small with a diameter in the range of 1 to 10 μm, or 2 to 4 μm. Many of such algae are members of Eustigmatophyta, such as but not limited to Nannochloropsis species (e.g., N. salina).

In certain embodiments, the algal composition of the invention comprises one or more algae from the following groups: Coelastrum, Chlorosarcina, Micractinium, Porphyridium, Nostoc, Closterium, Elakatothrix, Cyanosarcina, Trachelamonas, Kirchneriella, Carteria, Crytomonas, Chlamydamonas, Planktothrix, Anabaena, Hymenomonas, Isochrysis, Pavlova, Monodus, Monallanthus, Platymonas, Amphiprora, Chatioceros, Pyramimonas, Stephanodiscus, Chroococcus, Staurastrum, Netrium, and Tetraselmis.

In certain embodiments, any of the above-mentioned genus and species of algae may each be less preferred independently as a dominant species in, or be excluded from, an algal composition of the invention.

### 4.2 Fish

As used herein, the term fish refers to a member or a group of the following classes: Actinopteryii (i.e., ray-finned fish) which includes the division Teleosteri (also known as the teleosts), Chondrichytes (e.g., cartilaginous fish), Myxini (e.g., hagfish), Cephalospidomorphi (e.g., lampreys), and Sarcopteryii (e.g., coelacanths). The teleosts comprise at least 38 orders, 426 families, and 4064 genera. Some teleost families are large, such as Cyprinidae, Gobiidae, Cichlidae, Characidae, Loricariidae, Balitoridae, Serranidae, Labridae, and Scorpaenidae. In many embodiments, the invention involves bony fish, such as the teleosts, and/or cartilaginous fish. When referring to a plurality of organisms, the term “fish” is used interchangeably with the term “fish” regardless of whether one or more than one species are present, unless clearly indicated otherwise.

Stocks of fish used in the invention can be obtained initially from fish hatcheries or collected from the wild. Preferably, cultured or farmed fish are used in the invention. The fish may be fish fry, juveniles, fingerlings, or adult/mature fish. In certain embodiments of the invention, fry and/or juveniles that have metamorphosed are used. By “fry” it is meant a recently hatched fish that has fully absorbed its yolk sac, while by “juvenile” or “fingerling,” it is meant a fish that has not recently hatched but is not yet an adult. In certain embodiments, the fish may reproduce in an enclosure comprising algae within the system and not necessarily in a fish hatchery. Any fish aquaculture techniques known in the art can be used to stock, maintain, reproduce, and gather the fish used in the invention.

One or more species of fish can be used to harvest the algae from an algal composition. In one embodiment of the invention, the population of fish comprises only one species of fish. In another embodiment, the fish population is mixed and thus comprises one or several major species of fish. A major species is one that ranks high in the head count, e.g., the top one to five species with the highest head count relative to other species. The one or several major fish species may constitute greater than about 10%, about 20%, about 30%, about 40%, about 50%, about 60%, about 70%, about 75%, about 80%, about 90%, about 95%, about 97%, about 98% of the fish present in the population. In certain embodiments, several major fish species may each constitute greater than about 10%, about 20%, about 30%, about 40%, about 50%, about 60%, about 70%, or about 80% of the fish present in the population. In various embodiments, one, two, three, four, five major species of fish are present in a population of fish. Accordingly, a mixed fish population can be described and distinguished from other populations by the major species of fish present. The population can be further described by the percentages of the major and minor species, or the percentages of each of the major species. It is to be understood that in a body of water comprising a mixed fish population having the same genus or species of fish as another body of water may be different by virtue of the relative abundance of the various genus and/or species of fish present.

Fish inhabits most types of aquatic environment, including but not limited to freshwater, brackish, marine, and briny environments. As the present invention can be practiced in any of such aquatic environments, any freshwater species, stenohaline species, euryhaline species, marine species, species that grow in brine, and/or species that thrive in varying and/or intermediate salinities, can be used. Depending on the latitude of the system, fish from tropical, subtropical, temperate, polar, and/or other climatic regions can be used. For example, fish that live within the following temperature ranges can be used: below 10° C., 9° C. to 18° C., 15° C. to 25° C., 20° C. to 32° C. In one embodiment, fish indigenous to the region at which the methods of the invention are practiced, are used. Preferably, fish from the same climatic region, same salinity environment, or same ecosystem, as the algae are used. The algae and the fish are preferably derived from a naturally occurring trophic system.

In an aquatic ecosystem, fish occupies various trophic levels. Depending on diet, fish are classified generally as piscivores (carnivores), herbivores, planktivores, detritivores, and omnivores. The classification is based on observing the major types of food consumed by fish and its related adaptation to the diet. For example, many species of planktivores develop specialized anatomical structures to enable filter feeding, e.g., gill rakers and gill lamellae. Generally, the size of such filtering structures relative to the dimensions of plankton, including microalgae, affects the diet of a planktivore. Fish having more closing spaced gill rakers with specialized secondary structures to form a sieve are typically phytoplanktivores. Others having widely spaced gill rakers with secondary barbs are generally zooplanktivores. In the case of piscivores, the gill rakers are generally reduced to barbs. Herbivores generally feed on macroalgae and other aquatic vascular plants. Gut content analysis can determine the diet of an organism used in the invention. Techniques for analysis of gut content of fish are known in the art. As used herein, a planktivore is a phytoplanktivore if a population of the planktivore, reared in water with non-limiting quantities of phytoplankton and zooplankton, has on average more phytoplankton than zooplankton in the gut, for example, greater than 50%, 60%, 70%, 80%, or 90%. Under similar conditions, a planktivore is a zooplantivore if the population of the planktivore has on average more zooplankton than phytoplankton in the gut, for example, greater than 50%, 60%, 70%, 80%, or 90%. Certain fish can consume a broad range of food or can adapt to a diet offered by the environment. Accordingly, it is preferable that the fish are cultured in a system of the invention before undergoing a gut content analysis.

Fish that are used in the methods of the invention feed on algae, but it is not required that they feed exclusively on microalgae, i.e., they can be herbivores, omnivores, planktivores, phytoplanktivores, zooplanktivores, or generally filter feeders, including pelagic filter feeders and benthic filter feeders. In some embodiments of the invention, the population of fish useful for harvesting algae comprises predominantly planktivores. In some embodiments of the invention, the population of fish useful for harvesting algae comprises predominantly omnivores. In certain embodiments, one or several major species in the fish population are planktivores or phytoplanktivores. In certain mixed fish population of the invention, planktivores and omnivores are both present. In certain other mixed fish population, in addition to planktivores, herbivores and/or detritivores are also present. In certain embodiments, piscivores are used in a mixed fish population to harvest other fish. In certain embodiments, piscivores are less preferred or excluded from the systems of the invention. The predominance of one type of fish as defined by their trophic behavior over another type in a population of fish can be defined by percentage head count as described above for describing major fish species in a population (e.g., 90% phytoplanktivores, 10% omnivores).

The choice of fish for use in the harvesting methods of the invention depends on a number of factors, such as the palatability and nutritional value of the cultured algae as food for the fish, the lipid composition and content of the fish, the feed conversion ratio, the fish growth rate, and the environmental requirements that encourages feeding and growth of the fish. For example, it is preferable that the selected fish will feed on the cultured algae until satiation, and convert the algal biomass into fish biomass rapidly and efficiently. Gut content analysis can reveal the dimensions of the plankton ingested by a planktivore and the preference of the planktivore for certain species of algae. Knowing the average dimensions of ingested plankton, the preference and efficiency of a planktivore towards a certain size class of plankton can be determined. Based on size preference and/or species preference of the fish, a planktivore can be selected to match the size and/or species of algae in the algal composition. To reduce the need to change water when an algae composition is brought to the fish in an enclosure, the algae and fish are preferably adapted to grow in a similar salinity environment. The use of matched fish and algae species in the methods of the invention can improve harvesting efficiency. It may also be preferable to deploy combinations of algae and fish that are parts of a naturally occurring trophic system. Many trophic systems are known in the art and can be used to guide the selection of algae and fish for use in the invention. The population of fish can be self-sustaining and does not require extensive fish husbandry efforts to promote reproduction and to rear the juveniles.

Currently, many species of fish are farmed or captured for human consumption, making animal feed, including aquaculture feed, and a variety of other oleochemical-derived products, such as paints, linoleum, lubricants, soap, insecticides, and cosmetics. The methods of the invention can employ such species of fish that are otherwise used as human food, animal feed, or oleochemical feedstocks. Depending on the economics of operating an algal culture facility, some of the fish used in the present method can be sold as human food, animal feed or oleochemical feedstock. In certain embodiments, the fish used in the present invention are not suitable for making animal feed, human food, or oleochemical feedstock.

It should be understood that, in various embodiments, fish within a taxonomic group, such as a family or a genus, can be used interchangeably in various methods of the invention. The invention is described below using common names of fish groups and fish, as well as the scientific names of exemplary species. Databases, such as FishBase by Froese, R. and D. Pauly (Ed.), World Wide Web electronic publication, www.fishbase.org, version (06/2008), provide additional useful fish species within each of the taxonomic groups that are useful in the invention. It is contemplated that one of ordinary skill in art could, consistent with the scope of the present invention, use the databases to specify other species within each of the described taxonomic groups for use in the methods of the invention.

In certain embodiments of the invention, the fish population comprises fish in the order Acipeneriformes, such as but not limited to, sturgeons (trophic level 3), e.g., Acipenser species, Huso huso, and paddlefish (plankton-feeder), e.g., Psephurus gladius, Polyodon spathula, and Pseudamia zonata.

In certain embodiments of the invention, the fish used in the invention comprises fish in the order Clupeiformes, i.e., the clupeids, which include the following families: Chirocentridae , Clupeidae (menhadens, shads, herrings, sardines, hilsa), Denticipitidae, and Engraulidae (anchovies). Exemplary members within the order Clupeiformes include but are not limited to, the menhadens (Brevoortia species), e.g, Ethmidium maculatum, Brevoortia aurea, Brevoortia gunteri, Brevoortia smithi, Brevoortia pectinata, Gulf menhaden (Brevoortia patronus), and Atlantic menhaden (Brevoortia tyrannus); the shads, e.g., Alosa alosa, Alosa alabamae, Alosa fallax, Alosa mediocris, Alosa sapidissima, Alos pseudoharengus, Alosa chrysochloris, Dorosoma petenense; the herrings, e.g., Etrumeus teres, Harengula thrissina, Pacific herring (Clupea pallasii pallasii), Alosa aestivalis, Ilisha africana, Ilisha elongata, Ilisha megaloptera, Ilisha melastoma, Ilisha pristigastroides, Pellona ditchela, Opisthopterus tardoore, Nematalosa come, Alosa aestivalis, Alosa chrysochloris, freshwater herring (Alosa pseudoharengus), Arripis georgianus, Alosa chrysochloris, Opisthonema libertate, Opisthonema oglinum, Atlantic herring (Clupea harengus), Baltic herring (Clupea harengus membras); the sardines, e.g., Ilisha species, Sardinella species, Amblygaster species, Opisthopterus equatorialis, Sardinella aurita, Pacific sardine (Sardinops sagax), Harengula clupeola, Harengula humeralis, Harengula thrissina, Harengula jaguana, Sardinella albella, Sardinella janeiro, Sardinella fimbriata, oil sardine (Sardinella longiceps), and European pilchard (Sardina pilchardus); the hilsas, e.g., Tenuolosa species, and the anchovies, e.g., Anchoa species (A. hepsetus, A. mitchillis), Engraulis species, Thryssa species, anchoveta (Engraulis ringens), European anchovy (Engraulis encrasicolus), Engraulis eurystole, Australian anchovy (Engraulis australis), and Setipinna phasa, Coilia dussumieri. Most of these fish have not been commercially farmed because they are generally abundant in the oceans.

In certain embodiments of the invention, the fish population comprises fish in the superorder Ostariophysi which include the order Gonorynchiformes, order Siluriformes, and order Cypriniformes. Non-limiting examples of fish in this group include milkfish, catfish, barbs, carps, danios, zebrafish, goldfish, loaches, shiners, minnows, and rasboras. Milkfish, such as Chanos chanos, are plankton feeders. The catfish, such as channel catfish (Ictalurus punctatus), blue catfish (Ictalurus furcatus), catfish hybrid (Clarias macrocephalus), Ictalurus pricei, Pylodictis olivaris, Brachyplaiystoma vaillantii, Pinirampus pirinampu, Pseudoplatystoma tigrinum, Zungaro zungaro, Platynematichthys notatus, Ameiurus catus, Ameiurus melas are detritivores. The carps species included are freshwater herbivores, planktivores, and detritus feeders, e.g., common carp (Cyprinus carpio), Chinese carp (Cirrhinus chinensis), black carp (Mylopharyngodon piceus), silver carp (Hypophthalmichthys molitrix), bighead carp (Aristichthys nobilis) and grass carp (Ctenopharyngodon idella). Other useful herbivores, plankton and detritus feeders are members of the Labeo genus, such as but not limited to, Labeo angra, Labeo ariza, Labeo bata, Labeo boga, Labeo boggut, Labeo porcellus, Labeo kawrus, Labeo potail, Labeo calbasu, Labeo gonius, Labeo pangusia, and Labeo caeruleus.

In a preferred embodiment, the fish used in the invention are shiners. A variety of shiners that inhabit the Gulf of Mexico, particularly Northern Gulf of Mexico, can be used. Examples of shiners include but are not limited to, members of Luxilus, Cyprinella and Notropis genus, Alabama shiner (Cyprinella callistia), Altamaha shiner (Cyprinella xaenura), Ameca shiner (Notropis amecae), Ameca shiner (Notropis amecae), Apalachee shiner (Pteronotropis grandipinnis), Arkansas River shiner (Notropis girardi), Aztec shiner (Aztecula sallaei old), Balsas shiner (Hybopsis boucardi), Bandfin shiner (Luxilus zonistius), Bannerfin shiner (Cyprinella leedsi), Beautiful shiner (Cyprinella formosa), Bedrock shiner (Notropis rupestris), Bigeye shiner (Notropis boops), Bigmouth shiner (Hybopsis dorsalis), Blackchin shiner (Notropis heterodon), Blackmouth Shiner (Notropis melanostomus), Blacknose shiner (Can Quebec Notropis heterolepis), Blacknose shiner (Notropis heterolepis), Blackspot shiner (Notropis atrocaudalis), Blacktail shiner (Cyprinella venusta), Blacktip shiner (Lythrurus atrapiculus), Bleeding shiner (Luxilus zonatus), Blue Shiner (Cyprinella caerulea), Bluehead Shiner (Pteronotropis hubbsi), Bluenose Shiner (Pteronotropis welaka), Bluestripe Shiner (Cyprinella callitaenia), Bluntface shiner (Cyprinella camura), Bluntnose shiner (Notropis simus), Bluntnosed shiner (Selene setapinnis), Bridle shiner (Notropis bifrenatus), Broadstripe shiner (Notropis euryzonus), Burrhead shiner (Notropis asperifrons), Cahaba Shiner (Notropis cahabae), Cape Fear Shiner (Notropis mekistocholas), Cardinal shiner (Luxilus cardinalis), Carmine shiner (Notropis percobromus), Channel shiner (Notropis wickliffi), Cherryfin shiner (Lythrurus roseipinnis), Chihuahua shiner (Notropis chihuahua), Chub shiner (Notropis potteri), Coastal shiner (Notropis petersoni), Colorless Shiner (Notropis perpallidus), Comely shiner (Notropis amoenus), Common emerald shiner (Notropis atherinoides), Common shiner (Luxilus cornutus), Conchos shiner (Cyprinella panarcys), Coosa shiner (Notropis xaenocephalus), Crescent shiner (Luxilus cerasinus), Cuatro Cienegas shiner (Cyprinella xanthicara), Durango shiner (Notropis aulidion), Dusky shiner (Notropis cummingsae), Duskystripe shiner (Luxilus pilsbryi), Edwards Plateau shiner (Cyprinella lepida), Emerald shiner (Notropis atherinoides), Fieryblack shiner (Cyprinella pyrrhomelas), Flagfin shiner (Notropis signipinnis), Fluvial shiner (Notropis edwardraneyi), Ghost shiner (Notropis buchanani), Gibbous shiner (Cyprinella garmani), Golden shiner (Notemigonus crysoleucas), Golden shiner minnow (Notemigonus crysoleucas), Greenfin shiner (Cyprinella chloristia), Greenhead shiner (Notropis chlorocephalus), Highfin shiner (Notropis ahipinnis), Highland shiner (Notropis micropteryx), Highscale shiner (Notropis hypsilepis), Ironcolor shiner (Notropis chalybaeus), Kiamichi shiner (Notropis ortenburgeri), Lake emerald shiner (Notropis atherinoides), Lake shiner (Notropis atherinoides), Largemouth shiner (Cyprinella bocagrande), Longnose shiner (Notropis longirostris), Mexican red shiner (Cyprinella rutila), Mimic shiner (Notropis volucellus), Mirror shiner (Notropis spectrunculus), Mountain shiner (Lythrurus lirus), Nazas shiner (Notropis nazas), New River shiner (Notropis scabriceps), Ocmulgee shiner (Cyprinella callisema), Orangefin shiner (Notropis ammophilus), Orangetail shiner (Pteronotropis merlini), Ornate shiner (Cyprinella ornata), Ouachita Mountain Shiner (Lythrurus snelsoni), Ouachita shiner (Lythrurus snelsoni), Ozark shiner (Notropis ozarcanus), Paleband shiner (Notropis albizonatus), Pallid shiner (Hybopsis amnis), Peppered shiner (Notropis perpallidus), Phantom shiner (Notropis orca), Pinewoods shiner (Lythrurus matutinus), Plateau shiner (Cyprinella lepida), Popeye shiner (Notropis ariommus), Pretty shiner (Lythrurus bellus), Proserpine shiner (Cyprinella proserpina), Pugnose shiner (Notropis anogenus), Pygmy shiner (Notropis tropicus), Rainbow shiner (Notropis chrosomus), Red River shiner (Notropis bairdi), Red shiner (Cyprinella lutrensis), Redfin shiner (Lythrurus umbratilis), Redlip shiner (Notropis chiliticus), Redside shiner (Richardsonius balteatus), Ribbon shiner (Lythrurus fumeus), Rio Grande bluntnose shiner (Notropis simus), Rio Grande shiner (Notropis jemezanus), River shiner (Notropis blennius), Rocky shiner (Notropis suttkusi), Rosefin shiner (Lythrurus ardens), Rosyface shiner (Notropis rubellus), Rough shiner (Notropis baileyi), Roughhead Shiner (Notropis semperasper), Sabine shiner (Notropis sabinae), Saffron shiner (Notropis rubricroceus), Sailfin shiner (Notropis hypselopterus), Salado shiner (Notropis saladonis), Sand shiner (Notropis stramineus), Sandbar shiner (Notropis scepticus), Satinfin shiner (Cyprinella analostana), Scarlet shiner (Lythrurus fasciolaris), Sharpnose Shiner (Notropis oxyrhynchus), Notropis atherinoides, Notropis hudsonius, Richardsonius balteatus, Pomoxis nigromaculatus, Cymatogaster aggregata, Shiner Mauritania (Selene dorsalis), Silver shiner (Notropis photogenis), Silver shiner (Richardsonius balteatus), Silver shiner (Richardsonius balteatus), Silver shiner (Notropis photogenis), Silverband shiner (Notropis shumardi), Silverside shiner (Notropis candidus), Silverstripe shiner (Notropis stilbius), Skygazer shiner (Notropis uranoscopus), Smalleye Shiner (Notropis buccula), Soto la Marina shiner (Notropis aguirrepequenoi), Spotfin shiner (Cyprinella spiloptera), Spottail shiner (Notropis hudsonius), Steelcolor shiner (Cyprinella whipplei), Striped shiner (Luxilus chrysocephalus), Swallowtail shiner (Notropis procne), Taillight shiner (Notropis maculatus), Tallapoosa shiner (Cyprinella gibbsi), Tamaulipas shiner (Notropis braytoni), Telescope shiner (Notropis telescopus), Tennessee shiner (Notropis leuciodus), Tepehuan shiner (Cyprinella alvarezdelvillari), Texas shiner (Notropis amabilis), Topeka shiner (Notropis topeka), Tricolor shiner (Cyprinella trichroistia), Turquoise Shiner (Erimonax monachus), Warpaint shiner (Luxilus coccogenis), Warrior shiner (Lythrurus alegnotus), Wedgespot shiner (Notropis greenei), Weed shiner (Notropis texanus), White shiner (Luxilus albeolus), Whitefin shiner (Cyprinella nivea), Whitemouth shiner (Notropis alborus), Whitetail shiner (Cyprinella galactura), Yazoo shiner (Notropis rafinesquei), Yellow shiner (Cymatogaster aggregata), Yellow shiner (Notropis calientis), and Yellowfin shiner (Notropis lutipinnis).

In certain embodiments of the invention, the fish population comprises fish in the superorder Protacanthopterygii which include the order Salmoniformes and order Osmeriformes. Non-limiting examples of fish in this group include the salmons, e.g., Oncorhynchus species, Salmo species, Arripis species, Brycon species, Eleutheronema tetradactylum, Atlantic salmon (Salmo salar), red salmon (Oncorhynchus nerka), and Coho salmon (Oncorhynchus kisutch); and the trouts, e.g., Oncorhynchus species, Salvelinus species, Cynoscion species, cutthroat trout (Oncorhynchus clarkii), and rainbow trout (Oncorhynchus mykiss); which are trophic level 3 carnivorous fish. Other non-limiting examples include the smelts and galaxiids (Galaxia speceis). Smelts are planktivores, for example, Spirinchus species, Osmerus species, Hypomesus species, Bathylagus species, Retropinna retropinna, and European smelt (Osmerus eperlanus).

In certain embodiments of the invention, the fish population comprises fish in the superorder Acanthopterygii which include the order Mugiliformes, Pleuronectiformes, and Perciformes. Non-limiting examples of this group are the mullets, e.g., striped grey mullet (Mugil cephalus), which include plankton feeders, detritus feeders and benthic algae feeders; flatfish which are carnivorous; the anabantids; the centrarchids (e.g., bass and sunfish); the cichlids, the gobies, the gouramis, mackerels, perches, scats, whiting, snappers, groupers, barramundi, drums wrasses, and tilapias (Oreochromis sp.). Examples of tilapias include but are not limited to nile tilapia (Oreochromis niloticus), red tilapia (O. mossambicus x O. urolepis hornorum), mango tilapia (Sarotherodon galilaeus).

Algae are used as feed for larvae of certain shellfish that are used as human food, e.g., Mercenaria species (clams), Crassostrea species (oysters), Ostrea species, Pinctada species, Mactra species, Haliotis species (abalone), Pteria species, Patinopecten species (scallops). Invertebrate shellfish, bivalves, mollusks may reside in or be present within the enclosures of the invention, but they are not contemplated as a part of the present invention.

The following non-limiting examples of fish species can be used to harvest algae in or near the Gulf of Mexico: Brevoortia species such as B. patronus and B. tyrannus, species within Luxilus, Cyprinella and Notropis genus, Hyporhamphus unifasciatus, Sardinella aurita, Adinia xenica, Diplodus holbrooki, Dorosoma petenense, Lagodon rhombodides, Microgobius gulosus, Mugil species such as Mugil cephalus, Mugil cephalus, Mugil curema, Sphoeroides species such as Sphoeroides maculatus, Sphoeroides nephelus, Sphoeroides parvus, Sphoeroides spengleri, Aluterus schoepfi, Anguilla rostrata, Arius fens, Bairdella chrysoura, Bairdeiella chrysoura, Chasmodies species such as Chasmodes saburrae and Chasmodies saburrae, Diplodus holbrooki, Heterandria formosa, Hybopsis winchelli, Ictalurus species such as Ictalurus serracantus and Ictalurus punctatus, Leiostomus xanthurus, Micropogonias undulatus, Monacanthus ciliatus, Notropis texanus, Opisthonema oglinum, Orthopristis chrysoptera, Stephanolepis hispidus, Syndous foetens, Syngnathus species such as Syngnathus scovelli, Trinectes maculatus, Archosargus probatocephalus, Carpiodes species such as C. cyprinus and C. velifer, Dorosoma cepedianum, Erimyzon species such as Erimyzon oblongus, Erimyzon sucetta, and Erimyzon tenuis, Floridichthys carpio, Microgobius gulosus, Monacanthus cilatus, Moxostoma poecilurum, and Orthopristis chrysophtera.

Transgenic fish and genetically improved fish can also be used in the harvesting methods of the invention. The term “genetically improved fish” refers herein to a fish that is genetically predisposed to having a higher growth rate and/or a lipid content that is higher than a wild type fish, when they are cultured under the same conditions. Such fish can be obtained by traditional breeding techniques or by transgenic technology. Over-expression or ectopic expression of a piscine growth hormone transgene in a variety of fish resulted in enhanced growth rate. For example, the growth hormone genes of Chinook salmon, Sockeye salmon, tilapia, Atlantic salmon, grass carp, and mud loach have been used in creating transgenic fish (Zbikowska, 2003, Transgenic Research 12: 379-389; Guan et al., 2008, Aquaculture 284: 217-223). Transgenic carp or transgenic tilapia comprising an ectopically-expressed piscine growth hormone transgene are particularly useful in the harvesting methods of the invention.

### 4.3 Methods and Systems

Described below are the methods and systems of the invention for removing carbon dioxide (CO₂) from ocean water via algae and fish. In various embodiments, the methods of the invention comprise harvesting algae by feeding the algae to a population of fish, and processing the fish into useful products like oils and protein. As used herein the term “system” refers generally to the installations and apparatus for practicing the methods of the invention. The systems of the invention comprise water containing- enclosures that provide a multi-tropic aquatic environment that supports the growth of algae and/or planktivorous organisms, such as fish, and can emulate various aspects of an ecological system. The systems further comprise means for feeding algae to a population of fish thereby harvesting the algae, means for extracting oils and protein from the fish, and optionally means for culturing algae. The systems can comprise, independently and optionally, means for monitoring and/or controlling the aquatic environment in the enclosures, means for maintaining algal stock cultures, means for maintaining fish stocks, means for concentrating algae, means for storing algal biomass, means for storing fish biomass, means for conveying algae to fish, means for conveying fish to processing, and means to convert fish biomass into oils and proteins.

The term “fish enclosure” refers to a water-containing enclosure in which cultured algae are harvested by fish. The term “growth enclosure” refers to a water-containing enclosure in which the algae are grown and/or stored in water. Most of the algal growth takes place in the growth enclosure that is designed and equipped to optimize algal growth. Depending on the environment and economics of the operation, the methods and systems for harvesting algae can be integrated with the culturing of algae. In one embodiment of the invention, the algae and fish are cultured in the same enclosure wherein the fish and algae commingle in the same body of water, and the fish in the enclosure feed on the algae. The algae are cultured in the enclosure so the enclosure preferably has a surface area and depth that allow exposure of the algae to light. In this embodiment, the growth enclosure and the fish enclosure are effectively the same enclosure. In a particular embodiment, the fish and the algae reside in the same enclosure but the fish are confined or caged in a zone within the enclosure. The fish are gathered periodically or continuously from the enclosure.

In another embodiment of the invention, the algae and the fish are cultured separately for at least a period of time before the algae are fed to the fish. Algae are cultured in a growth enclosure and are made available in batches or continuously to fish that are separately kept in a fish enclosure. The algae in its growth enclosure can be but are not limited to a monoculture, a mixed algal culture, a mixed algal and fish culture, or a photobioreactor. The algae may share the same body of water in a system with the fish. An aquatic composition comprising algae can be introduced into a fish enclosure in which harvesting fish reside, and later returned to the growth enclosure that contains the bulk of the algae. Alternatively, the algae and the fish do not use the same body of water until the algae are fed to the fish. Accordingly, in certain embodiments of the invention, the methods can comprise the step of culturing the algae, culturing the fish, or culturing both, separately or together, in an enclosure.

The enclosures of the invention contains an aquatic composition comprising algae and/or fish, and are means for confining the algae and/or fish in an aquatic environment at a location on land, in a body of water, or at sea. The enclosures can be but are not limited to plastic bags, carboys, raceways, channels, tanks, cages, net-pens, ponds, and artificial streams. The enclosure can be of any regular or irregular shape, including but not limited to rectangular tanks, cages or ponds, or circular tanks, cages or ponds. A cage can be submerged, submersible or floating in a body of water, such as a lake, a bay, an estuary, or the ocean. A pond can be unlined or lined with any water-permeable materials, including but not limited to, cement, polyethylene sheets, or polyvinylchloride sheets. Example of ponds include but are not limited to earthen pond, lined pond, barrage pond, contour pond, and paddy pond. A pond can also be formed by erecting barriers that separate a water-containing area from a natural body of water. An enclosure can be formed by segregating a body of water by embankments, partitions and/or nets. Cages, net-pens and such like are used to confine the movement of the fish in an enclosure, or used as an enclosure in a body of water. The enclosures, such as ponds, can be organized in tracks on land, and cages can be organized in clusters in lakes or at sea so that they can share a host of operational and maintenance equipment. Fish of different trophic types, species, sizes, or ages, can be cultured separately in enclosures, cages, and net-pens.

In addition to algae and fish, in certain embodiments, the enclosures of the invention may comprise one or more additional aquatic organisms, such as but not limited to bacteria; plankton including zooplankton, such as but not limited to larval stages of fish (i.e., ichthyoplankton), tunicates, cladocera and copepoda; crustaceans, insects, worms, nematodes, mollusks and larval forms of the foregoing organisms; and aquatic plants. This type of culture system emulates certain aspects of an ecological system and is referred to as a multi-trophic system. The bacteria, plants, and animals constitute various trophic levels, and lend stability to an algal culture that is maintained in the open. These organisms can be introduced into the system or they may be present in the environment in which the culture system is established. However, zooplankton graze on microalgae and are generally undesirable if present in excess in an enclosure of the invention. They can be removed from the water by sand filtration or by keeping zooplanktivorous fish in the enclosure. The numbers and species of plankton, including zooplanktons, can be assessed by counting under a microscope using, for example, a Sedgwick-Rafter cell.

The growth enclosure(s) and/or fish enclosure(s) of the systems of the invention can each be closed or open, or a combination of open and closed enclosures. The enclosures can be completely exposed, covered, reversibly covered, or partly covered. The communication or material flow between a closed enclosure and its immediate aquatic and/or atmospheric environment is highly controlled relative to an open enclosure. Systems comprising open enclosures can be multi-trophic systems, with or without means for environmental controls. The size of an open enclosure of the invention can range, for example, from about 0.05 hectare (ha) to 20 ha, from about 0.25 to 10 ha, and preferably from about 1 to 5 ha. Systems comprising open enclosures that are situated on land can comprise one or more growth enclosure(s)and/or fish enclosure(s), which can be independently, ponds and/or raceways. The depth of such systems can range, for example, from about 0.3 m to 4 m, from about 0.8 m to 3 m, and from about 1 to 2 m. Raceways can be operated at shallow depths of 15 cm to 1 m. Typical dimensions for raceways are about 30:3:1 (length:width:depth) with slanted or vertical sidewalls. The systems can comprise a mix of different physical types of enclosures. The enclosures of the invention can be set up according to knowledge known in the art, see, e.g., Chapters 13 and 14 in Aquaculture Engineering, Odd-Ivar Lekang, 2007, Blackwell Publishing Ltd., respectively, for description of closed culturing systems and open culturing systems.

Most natural land-based water sources, such as but not limited to rivers, lakes, springs and aquifers, and municipal water supply can be used as a source of water for used in the systems of the invention. Seawater from the ocean or coastal waters, artificial seawater, brackish water from coastal or estuarine regions can also be a source of water. Irrigation water, eutrophic river water, eutrophic estuarine water, eutrophic coastal water, agricultural wastewater, industrial wastewater, or municipal wastewater can also be used in the systems of the invention. Optionally, one or more effluents of the system can be recycled within the system. The systems of the invention optionally comprise means for connecting the enclosures to each other, to other parts of the system and to water sources and points of disposal. The connections permit the operators to move and exchange water between parts of the system either continuously or intermittent, as needed. The connecting means, temporary or permanent, facilitates fluid flow, and can include but is not limited to a network of channels, hoses, conduits, viaducts, and pipes. The systems further comprise means for regulating the rate, direction, or both the rate and direction, of fluid flow throughout the network, such as flow between the enclosures and between the enclosures and other parts of the system. The flow regulating means can include but is not limited to pumps, valves, manifolds, and gates. Optionally, effluents from one or more enclosures are recycled generally within the system, or selectively to certain parts of the system.

The systems of the invention also provide means to monitor and/or control the environment of the enclosures, which includes but is not limited to the means for monitoring and/or adjusting, independently or otherwise, the pH, salinity, dissolved oxygen, alkalinity, nutrient concentrations, water homogeneity, temperature, turbidity, and other conditions of the water. The fish enclosures of the invention can operate within the following non-limiting, exemplary water quality limits: dissolved oxygen at greater than 5 mg/L, pH 6-10 and preferably pH from 6.5-8.2 for cold water fish and pH 7.5 to 9.0 for warm water fish; alkalinity at 10-400 mg/L CaCO₃; salinity at 0.1-3.0 g/L for stenohaline fish and 28-35 g/L for marine fish; less than 0.5 mg NH₃/L; less than 0.2 mg nitrite/L; and less than 10 mg/L CO₂, Equipment commonly employed in the aquaculture industry, such as thermometers, thermostats, pH meters, conductivity meters, dissolved oxygen meters, and automated controllers can be used for monitoring and controlling the aquatic environments of the system. For example, the pH of the water is preferably kept within the ranges of from about pH6 to pH9, and more preferably from about 8.2 to about 8.7. The salinity of seawater ranges preferably from about 12 to about 40 g/L and more preferably from 20 to 24 g/L. The temperature for seawater-based culture ranges preferably from about 16° C. to about 27° C. or from about 18° C. to about 24° C. Techniques and equipments commonly employed in the aquaculture industry can be used for monitoring the aquatic environments of the system. See, e.g., the instrumentation and monitoring technology described in Chapter 19 of Aquaculture Engineering, Odd-Ivar Lekang, 2007, Blackwell Publishing Ltd.

Generally, oxygen consumption by fish increases shortly after feeding, and water temperature regulates the rate of metabolism. The oxygen transport rate from water to fish is directly dependent on the partial oxygen pressure differences between fish blood (e.g., 50-110 mm Hg) and the dissolved oxygen concentration in water (e.g., 154-158 mm Hg at sea level), equilibrated to temperature and atmospheric pressure. During the day, the algae will provide oxygen and the fish will provide the CO₂. At night, both algae and fish will respire and may require active oxygenation. The systems of the invention can comprise means for delivering a gas or a liquid comprising a dissolved gas to the water in the systems, which include but are not limited to hoses, pipes, pumps, valves, and manifolds. Bubbles in the culture media can be formed by injecting gas, such as air, using a jet nozzle, sparger or diffuser, or by injecting water with bubbles using a venturi injector. Various techniques and means for oxygenation of water known in the art can be applied in the method of the invention, see, e.g., Chapter 8 in Aquaculture Engineering, Odd-Ivar Lekang, 2007, Blackwell Publishing Ltd. The addition of CO₂ promotes photosynthesis, and helps to maintain the pH of the culture below pH 9. Sources of CO₂ include, but is not limited to, synthetic fuel plants, gasification power plants, oil recovery plants, ammonia plants, ethanol plants, oil refinery plants, anaerobic digestion units, cement plants, and fossil steam plants. CO₂, either dissolved or as bubbles, at a concentration from about 0.05% to 1%, and up to 5% volume of air, can be introduced into the enclosures. Other instruments and technology for monitoring aquatic environments known in the art can be applied in the methods and systems of the invention, see, e.g., in Chapter 19 of Aquaculture Engineering, Odd-Ivar Lekang, 2007, Blackwell Publishing Ltd.

Depending on the source of water, it may be necessary to provide additional nutrients to sustain algal growth in the enclosures of the invention. The growth enclosures can be fertilized regularly according to conventional fishery practices. Nutrients can be provided in the faun of fertilizers, including inorganic fertilizers, such as but not limited to, ammonium sulfate, urea, calcium super phosphate, sodium metasilicate, sodium orthosilicate, sodium pyrosilicate, and silicic acid; and organic fertilizers, such as but not limited to, manure and agricultural waste.

The methods of the invention comprise a step of harvesting algae by feeding the algae to fish. The feeding of algae to fish encompasses any methods by which the algae and fish of the invention are brought into proximity of each other such that the fish can ingest the algae. Preferably, the systems are designed to make the algae accessible to the fish in an energy-efficient and controlled manner. The algae in an algal composition can be added to, pumped into, or allowed to flow into an enclosure in which the fish are held. An algal composition can be made available to the fish in batches or on a continuous basis. The algae can be distributed throughout the fish enclosure by any means, such as but not limited to agitation or aeration of the enclosure. The algae can also be dispensed at multiple locations in the fish enclosure. The algae can be distributed by water current in the enclosure in which the fish swim through.

While the fish are feeding on the algae, they may be swimming freely in the enclosure or they may be confined in one or more zones within the enclosure. The size and number of the zones in the fish enclosure may be controlled to adjust the density of fish per unit volume (e.g., in a chamber) or unit area (e.g., in a shallow enclosure). The zones may be established by membranes, nets, fixed cages, floating cages, partitions, or other means known in the art. The fish enclosure or zones therein provides several advantages. First, the enclosure or zone can be covered by netting to minimize predation by birds. Second, the enclosure or zone also allows simple harvesting by seining. Third, the enclosure or zone afford controls that limits the overconsumption of algae by the fish. However, still water is generally not preferred as it allows stratification and accumulation of waste products. In one embodiment of the invention, the fish enclosure is not zoned. In another embodiment, the algae flow past the fish within the fish enclosure or zones. Preferably, the fish within the enclosures or zones remain relatively stationary. In yet another embodiment, the fish are allowed access to the algae, for example, by allowing the fish to swim from one gated enclosure to the algae in another enclosure, or allowing the fish to swim to another zone within the enclosure that was not previously accessible. In yet another embodiment, the total number of fish or the number of a species of fish in an enclosure or a zone is increased or decreased. In various embodiments of the invention, the system is designed to minimize the energy that would be expended by the fish to acquire the algae, and to reduce physiological stress, such as overcrowding, low oxygen and waste accumulation. The systems of the invention comprises means for controlling the movement of fish in the system, means for adding fish to or removing fish from the system, such as but not limited to gates, channels, and portals, and means for removing dissolved and solid wastes (e.g., pumps and sinks), means for adding, removing, or relocating cages containing fish. Conventional fish hatcheries and farming techniques known in the art can be applied to implement the systems and methods of the invention, see, e.g., Chapters 10, 13, 15 in Aquaculture Engineering, Odd-Ivar Lekang, 2007, Blackwell Publishing Ltd.

It should be understood that the enclosure in which the fish are kept prior to feeding likely contains some algae at a background level. When the algae is added, pumped, or delivered to the water in which the fish are kept, the total amount of algae in the fish enclosure—the concentration of algae will rise above the background level initially. If the algae is not provided continuously, the amount of algae in the fish enclosure may decrease following feeding by the fish over a period of time. This situation also arises when the fish are allowed access to the algae by swimming to a fish enclosure that comprises the algae.

The algae can be delivered to the fish directly from an algal culture or it can be concentrated prior to being provided to the fish. The concentration of an algal composition can range from about 0.01 g/L, about 0.1 g/L, about 0.2 g/L, about 0.5 g/L to about 1.0 g/L. It should be understood that the concentration step does not require, nor does it exclude, that the algae be dried, dewatered, or reduced to a paste or any semi-solid state. The concentration step can be performed serially by one or more different techniques to obtain a concentrated algal composition. The concentration step serves the purpose of reducing the energy cost of transporting the algae to the fish and to reduce the volume of water that is transferred into the fish enclosure. A concentrated algal composition may be stored for a period of time, or fed to the fish immediately. It is contemplated that different batches of algae can be combined to form one or more algal compositions before the algae are being harvested in the fish enclosure. The algal composition can comprise different groups of algae in defined or undefined proportions. An algal composition can be designed to enhance the growth of the fish and/or the accumulation of lipids in the fish. In various embodiments, the algae are concentrated so that the number of algal cells per unit volume increases by two, five, 10, 20, 25, 30, 40, 50, 75, 100-fold, or more. For example, after a concentration step, the concentration of algae in an algal composition can range from at least about 0.2 g/L, about 0.5 g/L, about 1.0 g/L, about 2.0 g/L, about 5 g/L to about 10 g/L. An algal composition of the invention can be a concentrated algal culture or composition that comprises about 110%, 125%, 150%, 175%, 200% (or 2 times), 250%, 500% (or 5 times), 750%, 1000% (10 times) or 2000% (20 times) the amount of algae in the original culture or in a preceding algal composition. The algae can also be dried to remove most of the moisture (water<1%). The resulting concentrated algae composition can be a solid, a semi-solid (e.g., paste), or a liquid (e.g., a suspension), and it can be stored or used immediately. The concentrated algal composition can be held in one or more separate enclosures. Any techniques and means known in the art for concentrating the algae can be applied, including but not limited to centrifugation, filtration, sedimentaion, flocculation, and foam fractionation. See, e.g., Chapter 10 in Handbook of Microalgal Culture, edited by Amos Richmond, 2004, Blackwell Science, for description of downstream processing techniques.

The fish of the invention are selected to maintain the feed conversion ratio (FCR) within a range that can optimize the net energy produced by the system. The FCR is calculated from the kilograms of feed that are used to produce one kilogram of whole fish, and reflects how efficiently the feed is converted into fish biomass. The particular value of FCR is based, in part, on the metabolism of the particular species of fish, the digestibility of the food, its nutritional characteristics, and the quantity of food. Overfeeding or underfeeding a fish can vary the FCR, while feeding a fish to satiation can reduce the FCR because satiated fish are not stressed, and produce dense, high quality flesh. Thus, controlling the concentration and species composition of algae on which the fish feed can be useful for optimizing the FCR, such as by reducing the FCR in a system. The FCR can also depend on the particular food source, for example, some fish species are particularly well adapted to using oils and fats as their prime energy source. Thus, selecting algae species with a high oil/fat content can reduce the FCR for a species of fish. In some embodiments, the species of fish has an FCR of less than about 3, less than about 2, less than about 1.5, less than about 1.0, less than about 0.8, or less than 0.6.

A feeding regimen can be established to encourage the feeding of the fish on the algae to a predetermined ration level or to satiation, in order to accelerate the growth rate, and to maximize gain in fish biomass. For example, an excess of algae is made available to the fish up to or above the limiting maximum stomach volume of the fish. The feeding process, water temperature in the fish enclosure, the growth of fish in size and/or in biomass, can be monitored, quantified and tabulated by methods well known in the art. Energy requirements of fish are calculated from maintenance requirements (fasted animals), growth rate, water temperature, and losses during food utilization (Cho, 1992, Aquaculture 100: 107-123). The collected data, for example, in the form of a feeding table, can be used to fine-tune various parameters of the system to maximize biomass yield. The systems of the invention provides means for feeding a controlled amount of algae to the fish. The systems of the invention can provide a feeding subsystem to control the feeding of algae to the fish. Many feeding mechanisms are known in the art, see, e.g., Chapter 16, Aquaculture Engineering, Odd-Ivar Lekang, 2007, Blackwell Publishing Ltd.

The density of algae in the fish enclosure can be monitored and adjusted to promote feeding at a predetermined rate or to satiation, such as by maintaining the density at a constant level that is at least about 50%, about two times, about three times, about five times, about 10 times, about 20 times, or about 50 times the average amount of algae normally present in a natural aquatic environment, such as a local aquatic environment in which the endemic species coexist. For example, the algae can be present at a concentration of greater than about 10, 25, 50, 75, 100, 250, 500, 750, 1000 mg/L, or about 10 to about 500 mg/L, about 50 to about 200 mg/L, or about 200 to 1000 mg/L. In embodiments where the fish are fed in a batchwise manner, the algae may be provided once a day, twice a day, once a week, twice a week, or three times a week, or whenever the density of algae in the fish enclosure falls below a predeteiinined level. The algae in the fish enclosure are the major source of food that provide energy and support growth of the fish, although natural bodies of water will contain phytoplanktivorous organisms, such as zooplankton, which also serve as food for the fish. In essence, the zooplankton serve as an intermediary algae harvester. Vitamins, such as thiamin, riboflavin, pyroxidine, folic acid, panthothenic acid, biotin, inositol, choline, niacin, vitamin B12, vitamin C, vitamin A, vitamin D, vitamin E, vitamin K; and minerals, such as but not limited to calcium, phosphorous, magnesium, iron, copper, zinc, manganese, iodine and selenium, required for optimal fish growth which may not be sufficiently provided by the algae, and other aquaculture additives, such as antibiotics, may be provided separately. Preferably, while the fish are consuming the algae, the fish in the enclosure are provided with a minimum, if any, of other aquaculture feedstuff (e.g., agricultural feedstuff, silage, pelleted commercial intensive feeds) to provide energy and sustain growth. In certain embodiments, the fish of the invention are fed exclusively cultured algae, optionally presented in the form of a concentrated algal composition. The systems of the invention also comprise means for providing supplemental aquaculture feed and aquaculture additives to the fish, such as various types of automated feeders, including demand feeders, adaptive feedback feeders, and fixed ration feeders. The feeders can also be adapted to supply the fish with algae of the invention.

Depending on the site and the type of fish used, for a system comprising open enclosures, the fish can be introduced at various density from about 50 to 100, about 100 to 300, about 300 to 600, about 600 to 900, about 900 to 1200, and about 1200 to 1500 individuals per m². The enclosures of the invention can be characterized by their loading density and carrying capacity. The loading density of a fish enclosure is the total fish biomass housed within the enclosure. The carrying capacity is the fish biomass in the enclosure without compromising water quality, fish nutrition, or fish health. Carrying capacity is a function of water flow, enclosure volume, exchange rate, rearing temperature, dissolved oxygen, metabolic wastes (e.g., ammonia), which can be adjusted by techniques known in the art. Loading density and carrying capacity are measured either by a density index (in units of fish weight per volume/space, e.g., lb/cubic feet, kg/ha) or by a water flow index governed by oxygen consumption (in units of fish weight per volume per minute, kg/L/min). For example, the loading density ranges from about 0.5 to 1 pound of fish per 2 gallons of water with saturated oxygen levels.

As the fish feed on algae and grow over time, the carrying capacity of an enclosure may not be adequate. It is contemplated that the fish may be transferred from a first enclosure to a second enclosure with a larger carrying capacity to reduce stress and thus allow the fish to grow rapidly. The loading density of the second enclosure is initially lower than that of the first enclosure. The algae consumption by the population of fish cannot exceed the algae production rate or else algae population will crash. As the population of fish grows, their algae consumption will also increase and therefore the number of fish needs to be removed from the system by either harvesting or transferring to a different enclosure. Depending on the age of the fish, they may be transferred successively to various enclosures of the system with different, possibly larger, carrying capacities. The transfer can be effected by allowing the fish to swim from one enclosure to another enclosure or manual capture (e.g., netting) and movement. Alternatively, the growing fish population may be divided periodically among several enclosures. The residence time in each water enclosure depends on the growth rate and the carrying capacity of the enclosure. If the system is designed such that various aspects of water quality can be adjusted, the fish may remain in an enclosure while the parameters within the enclosure are changed to accommodate the needs of growing fish. In one embodiment of the invention, the enclosure is maintained at carrying capacity until just before the fish is ready for processing when the enclosure is switched to operating towards maximizing loading density.

Depending on the growth rate and life cycle of the fish, they can be gathered at any time after they have fed on the algae and gained sufficient biomass for fish oil and fishmeal processing, or to mitigate against overgrazing. It is contemplated that fish fry, juveniles, fingerlings, and/or adult fish, can be used initially to stock the fish enclosure. As the fish fry, fingerlings or juveniles become adults that have grown to reach or exceed a desired biomass, they are gathered from the enclosure and optionally, kept in a separate holding enclosure. In one embodiment of the invention, the fish are gathered when a certain percentage of fish in the population reach maturity, or when the biomass of a percentage of the fish reaches a predetermined level referred to herein as a biomass set point. The percentage of fish in the population that reaches or exceeds the set point can be at least about 20%, at least about 30%, at least about 40%, at least about 50%, at least about 60%, at least about 70%, at least about 80%, at least about 90% or at least about 95%. Various sampling methods known in the art can be used to assess the percentage for a population of fish.

A fish biomass set point, measurable in terms of the gain of biomass over a period of time, is used to determine the time when the fish are gathered or captured for processing. In one embodiment of the invention, the set point can be the average or median biomass of an adult fish of one of the major fish species in the population. The set point can be the weight, length, body depth, or fat content of the fish at a certain age ranging from 2 weeks old to 3 years old or more, such as but not limited to, 2 weeks, 4 weeks, 8 weeks, 3 months, 6 months, 9 months, 12 months, 15 months, 18 months, 21 months, or 24 months. For example, the set point can be the 2-week weight, 2-week length, 2-week body depth, 2-week fat content, 4-week weight, 4-week length, 4-week body depth, 4-week fat content, 8-week weight, 8-week length, 8-week body depth, 8-week fat content, 3-month weight, 3-month length, 3-month body depth, 3-month fat content, 6-month weight, 6-month length, 6-month body depth, 6-month fat content, 9-month weight, 9-month length, 9-month body depth, 9-month fat content, 12-month weight, 12-month length, 12-month body depth, 12-month fat content, 15-month weight, 15-month length, 15-month body depth, 15-month fat content, 18-month weight, 18-month length, 18-month body depth, 18-month fat content, 21-month weight, 21-month length, 21-month body depth, 21-month fat content, 24-month weight, 24-month length, 24-month body depth, or 24-month fat content of one of the major species of fish in the enclosure. In another embodiment of the invention, the set point can be the biomass of one of the major species of fish when the growth rate of the species reaches a plateau under the culture conditions in the fish enclosure. The set point can also be based on the biomass of separate parts of a fish, e.g., fish fillet, fish viscera, head, liver, guts, testes, and ovary. The fillet weight and viscera weight of a fish can be measured to monitor growth. The lipid content of the fillet and viscera of the fish can be determined by methods known in the art, and are typically within the range of about 10%-20% (fillet) and 10% to 40% (viscera) by weight.

In another embodiment, the invention provides systems and methods that are based on co-culturing both the algae and the fish in an enclosure while the fish harvest the algae continuously. The aquatic conditions in the enclosure are optimized so that the productivity of algal biomass (measurable in terms of algal biomass gained per unit volume per unit time) is maintained at a maximum level over a period of time. The yield of fish biomass from such systems is determined by the growth rate of the fish, which is a product of the algae growth rate, the feeding rate of the fish, the digestibility of the algae, and the energy conversion efficiency from algae to fish. As the fish grow to maturity in the enclosure, they harvest more algae which can significantly reduce the concentration of the algae in the enclosure. Overgrazing by the fish can adversely affect productivity because it takes time for the algae in an enclosure to recover. Since the productivity of the system is ultimately based on algal photosynthesis, it is advantageous to maintain the concentration of algae at a constant level or within a defined range, i.e., a set point based on algal biomass. An algal biomass set point can be the concentration of algae in an enclosure or a zone thereof, which can range from 1 to 1000 mg/L, including but not limited to 1, 2, 5, 10, 20, 30, 40, 50, 75, 100, 200, 300, 400, 500, 600, 700, 800, 900, and 1000 mg/L.

It is advantageous to achieve a balance between algae productivity and harvesting. The concentration of algae in an enclosure can be maintained by controlling the number or size of fish in the enclosure that in turn controls the rate of harvesting of the algae in the enclosure. In such systems, the fish are preferably confined to a zone or in cages, such that the total number of fish or the number of a species of fish can be monitored and regulated. In a specific embodiment, the productivity of algae (g/m²/day) in an enclosure determines the total number of fish, the size distribution of one or more species of fish, the age distribution of one or more species of fish, or the time when a plurality of the fish is gathered and removed from the system. In other embodiments, the productivity of algae in a growth enclosure determines the distribution of the algae to different combinations of type, size, and number of fish in a plurality of enclosure. The age range of the fish can be from 2 weeks old to 3 years old or more, such as but not limited to, 2 weeks, 4 weeks, 8 weeks, 3 months, 6 months, 9 months, 12 months, 15 months, 18 months, 21 months, or 24 months. The size range of the fish can be measured in terms of weight, length or body depth as described above for fish biomass set point. In another embodiment, the feeding rate is controlled by regulating the flow rate of algae to the fish in an enclosure or a zone thereof, or in cages. The flow rate of algae can be regulated by changing the degree of mixing in an enclosure or in the vicinity of a zone or a cage. Accordingly, the methods of the invention comprise increasing or decreasing the total number of fish, the number of one or more species of fish, the number of fish of a defined size range, or the number of fish of a defined age range, in an enclosure, a zone thereof, or a cage. In a specific embodiment, one or more cages comprising fish, preferably fish of defined species, size, and/or age, can be added to or removed from an enclosure.

The total residence time of a fish population in one or more fish enclosures of the system wherein the fish are fed with the algae may range from about 30 to 90 days, about 12 to 24 weeks, or about 6 to 24 months. The fish can be gathered or harvested by any methods or means known in the art. In some embodiments, a fish gathering or capturing means is configured to separate fish based on a selected physical characteristic, such as density, weight, length, or size. The harvesting systems of the invention comprise means to gather or capture fish, which can be mechanical, pneumatic, hydraulic, electrical, or a combination of mechanisms. In one embodiment, the fish gathering device is a net that is either automatically or manually drawn through the water in order to gather or capture the fish. The net, with fish therein, can then be withdrawn from the pond. Alternately, a fish gathering device can comprise traps, or circuits for applying DC electrical pulses to the water. See, e.g., Chapters 17 and 19 in Aquaculture Engineering, Odd-Ivar Lekang, 2007, Blackwell Publishing Ltd., for description of techniques and means for moving and grading fish.

Any fish processing technologies and means known in the art can be applied to obtain lipids and hydrocarbons from the fish. In one embodiment of the invention, the entire fish is processed to extract lipids without separating the fish fillet from other parts of the fish that are regarded as fish waste in the seafood industry. In another embodiment, only certain part(s) of the fish are used, e.g., non-fillet parts of a fish, fish viscera, head, liver, guts, testes, and/or ovary. Prior to being processed, the fish of the invention are not treated to prevent or remove off-flavor taste of the flesh. The treatment may include culturing the fish for a period from one day up to two weeks in an enclosure that has a lower algae and/or bacteria count than the fish enclosure.

Described below is an example of a method for processing the fish of the invention. The processing step involves heating the fish to greater than about 70° C., 80° C., 90° C. or 100° C., typically by a steam cooker, which coagulates the protein, ruptures the fat deposits and liberates lipids and oil and physico-chemically bound water, and; grinding, pureeing and/or pressing the fish by a continuous press with rotating helical screws. The fish can be subjected to gentle pressure cooking and pressing which use significantly less energy than that is required to obtain lipids from algae. The coagulate may alternatively be centrifuged. This step removes a large fraction of the liquids (press liquor) from the mass, which comprises an oily phase and an aqueous fraction (stickwater). The separation of press liquor can be carried out by centrifugation after the liquor has been heated to 90° C. to 95° C. Separation of stickwater from oil can be carried out in vertical disc centrifuges. To obtain fishmeal, the separated water is evaporated to form a concentrate (fish solubles) that is combined with the solid residues, and then dried to solid form (presscake). The dried material may be grinded to a desired particle size. The fishmeal typically comprises mostly proteins (up to 70%), ash, salt, carbohydrates, and oil (about 5-10%). The fishmeal can be used as animal feed.

In another embodiment of the invention, the fishmeal is subjected to a hydrothermal process that extracts residual lipids, both neutral and polar. A large proportion of polar lipids, such as phospholipids, remain with the fishmeal. Thhydrothermal process of the invention generally comprises treating fishmeal with near-critical or supercritical water under conditions that can extract polar lipids from the fishmeal and/or hydrolyze polar lipids resulting in fatty acids. The fishmeal need not be dried as the moisture in the fishmeal can be used in the process. The process comprises applying pressure to the fish to a predefined pressure and heating the fishmeal to a predefined temperature, wherein lipids in the fishmeal are extracted and/or hydrolyzed to form fatty acids. The fishmeal can be held at one or more of the preselected temperature(s) and preselected pressure(s) for an amount of time that facilitates, and preferably maximizes, hydrolysis and/or extraction of various types of lipids. The term “subcritical” or “near-critical water” refers to water that is pressurized above atmospheric pressure at a temperature between the boiling temperature (100° C. at 1 atm) and critical temperature (374° C.) of water. The term “supercritical water” refers to water above its critical pressure (218 atm) at a temperature above the critical temperature (374° C.). In some embodiments, the predefined pressure is between 5 atm and 500 atm. In some embodiments, the predefined temperature is between 100° C. and 500° C. or between 325° C. and 425° C. The reaction time can range between 5 seconds and 60 minutes. For example, fishmeal can be exposed to a process condition comprising a temperature of about 300° C. at about 80 atm for about 10 minutes. The selection of an appropriate set of process conditions, i.e., combinations of temperature, pressure, and process time can be determined by assaying the quantity and quality of lipids and free fatty acids, e.g., neutral lipids, phospholipids and free fatty acids, that are produced. The process further comprise separating the treated fishmeal into an organic phase which includes the lipids and/or fatty acids, an aqueous phase, and a solid phase.

The systems of the invention can comprise, independently and optionally, means for gathering fish from which lipids are extracted (e.g., nets), means for conveying the gathered fish from the fish enclosure or a holding enclosure to the fish processing facility (e.g., pipes, conveyors, bins, trucks), means for cutting large pieces of fish into small pieces before cooking and pressing (e.g., chopper, hogger), means for heating the fish to about 70° C., 80° C., 90° C. or 100° C. (e.g., steam cooker); means for grinding, pureeing, and/or pressing the fish to obtain lipids (e.g., single screw press, twin screw press, with capacity of about 1-20 tons per hour); means for separating lipids from the coagulate (e.g., decanters and/or centrifuges); means for separating the oily phase from the aqueous fraction (e.g., decanters and/or centrifuges); and means for polishing the lipids (e.g., reactor for transesterification or hydrogenation). Many commercially available systems for producing fishmeal can be adapted for use in the invention, including stationary and mobile systems that are mounted on a container frame or a flat rack.

### 4.4 Carbon Credits

As used herein the term “carbon credit” or “carbon credits” refers generally to any tradable certificate or permit representing the right to emit one ton of CO₂ equivalent. See, e.g., Collins English Dictionary—Complete & Unabridged 10th Edition. Carbon credit. William Collins Sons & Co. Ltd, Harper Collins Publishers, 2009.

The European Union Emission Trading System (EU ETS), which began operation in January 2005, is the largest multi-national, multi-sector greenhouse gas emissions trading scheme in the world. The system was set up as the EU's response to the Kyoto Protocol to the United Nations Framework Convention on Climate Change which was negotiated in 1997 and ratified in 2005. It is a commitment among participating industrialized nations to curb the rise in global temperature by abating their emissions of six greenhouse gases including CO₂, methane, nitrous oxide, sulfur hexafluoride, perfluorocarbons and hydrofluorocarbons.

The EU ETS is monitored and regulated by the EU Commission. The EU Commission places limitations on greenhouse gas which are satisfied through the trading of EU emission allowances. The goal is to force companies to find the lowest cost of abatement by decreasing their greenhouse gas internally and selling any unused emission allowances into the market.

Participating countries in the EU ETS submit their target greenhouse gas reductions through National Allocation Plans which then are approved by the EU Commission. As one example of an established system, the European Bank for Reconstruction and Development (EBRD) and the European Investment Bank (EIB) established the Multilateral Carbon Credit Fund (MCCF) for countries from Central Europe to Central Asia.

By joining the MCCF, private and public companies as well as EBRD and EIB shareholder countries can purchase carbon credits from emission reduction projects financed by the EIB or EBRD to meet their mandatory or voluntary greenhouse gas emission reduction targets. Shareholder countries can also set quotas on the emissions of installations run by local business and other organizations.

In addition to the project credits, countries can also participate via the MCCF in green investment schemes. This is an innovative way to facilitate government-to-government trade in carbon credits, whereby the selling country uses the revenue from the sale of carbon credits to support investments in climate-friendly projects. Carbon credits can be generated from a large variety of project types, all of which reduce or avoid green house gas emissions. These include credits produced from renewable energy such as biomass.

In some embodiments, the present invention creates or assigns carbon credits for trading by producing biomass carbon. In other embodiments, the present invention creates or assigns carbon credits for trading by removing CO₂ from water. The present invention is not limited to any particular mechanism of action. Indeed, an understanding of the mechanism of action is not needed to practice the present invention. Nevertheless, it is contemplated that the use of algae to remove CO₂ in the water through photosynthesis, followed by harvesting of the algae by fish that feed on the algae, is a highly efficient method to remove CO₂ from water. In this method, the CO₂ removed from the water is converted into algal biomass carbon, and the algal biomass carbon is converted into fish biomass carbon, which is processed into useful products, or quantified for calculation of carbon credits.

Carbon credits can be obtained, for example, by applying and receiving certification for the amount of carbon emissions reduced (e.g., the amount of CO₂ removed from water and therefore not released into the atmosphere). The quality of the credits can be based in part on validation processes and the sophistication of funds or development companies that act as sponsors to carbon projects. See, e.g., U.S. Patent Publication No. 2010/0049673 for representative methods for verifying and valuing carbon credits.

Carbon credits can be exchanged between businesses or bought and sold in national or international markets at a prevailing market price. In addition, businesses can sell carbon credits to commercial and individual customers who are interested in voluntarily offsetting their carbon footprints. These businesses may, for example, purchase the credits from an investment fund or a carbon development company that has aggregated the credits from individual projects. Further, business that have not used up their quotas can sell their unused allowances as carbon credits, while businesses that are about to exceed their quotas can buy the extra allowances as credits, privately or on the open market.

### 4.5 Optimizing Removal Of Carbon Dioxide From Water

The methods of the invention contemplate that the amount of CO₂ removed from the water may be optimized by monitoring and/or controlling the aquatic environment of the water-containing enclosure(s) in which the cultured algae are harvested by the fish. Without intending to be bound by any particular theory or mechanism, it is believed that by monitoring and/or controlling the aquatic environment of the water-containing enclosure(s) to optimize the efficiency of conversion of CO₂ in the water into algal biomass carbon, and to optimize the conversion of algal biomass carbon into fish biomass carbon, the amount of CO₂ removed from the water is thereby also optimized.

The aquatic environment may be monitored and/or controlled by monitoring and/or adjusting, independently or otherwise, such aquatic variables as pH, salinity, dissolved oxygen, alkalinity, nutrient concentrations, water homogeneity, temperature, turbidity, algae culture, and fish stock, or any other conditions of the water that supports the growth of the algae and the fish.

The aquatic environment may also be monitored and/or controlled by monitoring and/or adjusting, independent or otherwise, any number of additional variables that support the growth of the algae, and therefore, the conversion of CO₂ in the water into algal biomass carbon. For example, depending on the source of water, additional nutrients may be provided to sustain algal growth in the enclosure(s) of the invention. The aquatic conditions in the enclosure(s) may also be optimized so that the productivity of algal biomass is maintained at a maximum level over a period of time.

The aquatic environment may further be monitored and/or controlled by monitoring and/or adjusting, independent or otherwise, any number of additional variables that supports the growth of the fish, and therefore, the conversion of algal biomass carbon into fish biomass carbon. For example, the algae may be concentrated prior to being provided to the fish, or may be designed to enhance the growth of the fish. The density of algae in the enclosure(s) may also be monitored and adjusted to promote fish feeding at a predetermined rate or to satiation. The fish may be selected to maintain the feed conversion ratio (FCR) within a range that can optimize the net energy produced by the system, i.e., how efficiently the algae feed is converted into fish biomass. A feeding regimen may be established to accelerate the growth rate of the fish, and to maximize gain in fish biomass. The feeding rate of the fish may be controlled by regulating the flow rate of algae to the fish in the enclosure(s). The fish may be introduced at various densities, according to the loading densities and carrying capacities of the enclosure(s). The fish may also be transferred successively to various enclosures with different carrying capacities, or may be divided periodically among several enclosures. Depending on the growth rate and life cycle of the fish, they may be gathered at any time after they have fed on the algae and gained sufficient biomass, or to mitigate against overgrazing.

The methods of the invention also contemplate that the amount of CO₂ removed from the water may be quantified based on the fish biomass produced. As explained above, fish biomass is approximately 50% carbon by dry weight, and CO₂ is approximately 27% carbon by weight. Thus, one mass unit of dry fish biomass is equivalent to 1.83 carbon units (1.83=0.5/0.27). These carbon units may be traded in established carbon credit trading programs such as those established under the Kyoto protocol. Thus, by optimizing removal of CO₂ from the water to produce fish biomass, the creation of tradable carbon credits is also optimized to generate greenhouse gas savings.

The methods of the invention further contemplate comparison of the carbon units calculated from the fish biomass to a reference number of carbon units, for example, an assigned emission allowance or quota. This allowance or quota may be in the form of Assigned Amount Units (AUUs), which represents an allowance to emit one metric ton of CO₂ equivalent (see “Kyoto Protocol Reference Manual On Accounting of Emissions and Assigned Amount,” United Nations Framework Convention on Climate Change. November 2008). If the carbon units calculated from the fish biomass are above an assigned emission allowance, the variables in the aquatic environment may be adjusted such that the amount of CO₂ removed from the water is decreased. If the carbon units calculated from the fish biomass are below the assigned emission allowance, the variables in the aquatic environment may be adjusted such that the amount of CO₂ removed from the water is increased. Thus, by adjusting the variables in the aquatic environment, businesses may adjust their carbon credits to meet, exceed, or not use up their quotas, so as to allow flexibility and predictability in meeting their business objectives.

Technical and scientific terms used herein have the meanings commonly understood by one of ordinary skill in the art to which the present systems and methods pertain, unless otherwise defined. Reference is made herein to various methodologies known to those of skill in the art. Publications and other materials setting forth such known methodologies to which reference is made are incorporated herein by reference in their entireties as though set forth in full. The practice of certain embodiments provided herein will employ, unless otherwise indicated, techniques of chemistry, biology, the aquaculture industry and the algae industry, which are within the skill of the art. Such techniques are explained fully in the literature, e.g., Aquaculture Engineering, Odd-Ivar Lekang, 2007, Blackwell Publishing Ltd.; Handbook of Microalgal Culture, edited by Amos Richmond, 2004, Blackwell Science; Microalgae Biotechnology and Microbiology, E. W. Becker, 1994, Cambridge University Press; Limnology: Lake and River Ecosystems, Robert G. Wetzel, 2001, Academic Press, each of which are incorporated by reference in their entireties.

All references cited herein are incorporated herein by reference in their entirety and for all purposes to the same extent as if each individual publication or patent or patent application was specifically and individually indicated to be incorporated by reference in its entirety for all purposes.

Many modifications and variations of the embodiments provided herein can be made without departing from its spirit and scope, as will be apparent to those skilled in the art. The specific embodiments described herein are offered by way of example only, and the embodiments are to be limited only by the terms of the appended claims along with the full scope of equivalents to which such claims are entitled.

What is claimed:

1. A method for removing carbon dioxide from water, said method comprising:
(i) harvesting algae by fish that feed on the algae; and
(ii) processing fish into useful products;
wherein the fish harvest the algae in an aquatic environment.

2. The method of claim 1, wherein the useful products are fish oils or fishmeal.

3. The method of claim 1, wherein the aquatic environment is controlled by monitoring and/or adjusting an aquatic variable selected from the group consisting of pH, salinity, dissolved oxygen, alkalinity, nutrient concentrations, water homogeneity, temperature, turbidity, algae culture, and fish stock.

4. The method of claim 3, wherein the aquatic variables are adjusted to optimize removal of the carbon dioxide from the water.

5. A method for removing carbon dioxide from water, said method comprising:
(i) feeding algae to a population of fish in a water-containing enclosure; and
(ii) gathering the fish from the enclosure, and extracting oil and fishmeal from the fish.

6. A method for removing carbon dioxide from water, said method comprising:
(i) converting the carbon dioxide in the water into algal biomass carbon; and
(ii) converting the algal biomass carbon into fish biomass carbon.

7. The method of claim 6, wherein the method further comprises measurement of a feed conversion ratio.

8. The method of claim 7, wherein the feed conversion ratio is maintained within a range that optimizes carbon dioxide removal from the water.

9. The method of claim 5 or 6, further comprising assigning tradable credits to the carbon dioxide removed from the water.

10. A controlled system for removing carbon dioxide from water, said system comprising:
(i) a means for harvesting algae by fish that feed on the algae;
(ii) a means for processing fish into useful products; and
(iii) a means for connecting (i) and (ii).

11. The system of claim 10, wherein the means for harvesting algae comprises growth enclosure(s) and/or fish enclosure(s), wherein the enclosure(s) can each be closed or open, or a combination of open and closed enclosures.

12. The system of claim 11, wherein communication or material flow between a closed enclosure and its immediate aquatic and/or atmospheric environment is highly controlled relative to an open enclosure.

13. A method of optimizing removal of carbon dioxide from water, said method comprising:
(i) converting the carbon dioxide in the water into algal biomass carbon;
(ii) converting the algal biomass carbon into fish biomass carbon; and
(iii) quantifying the fish biomass carbon of step (ii);
wherein steps (i) and (ii) take place in an aquatic environment.

14. The method of claim 13, wherein the amount of fish biomass carbon quantified is used to calculate tradable carbon credits.

15. The method of claim 14, wherein tradable carbon credits above a certain allowance indicates that the amount of carbon dioxide removed from the water may be decreased, and tradable carbon credits below a certain allowance indicates that the amount of carbon dioxide removed from the water may be increased.

16. The method of claim 13, wherein the amount of carbon dioxide removed from the water may be increased or decreased by controlling the aquatic environment.

17. The method of claim 16, wherein the aquatic environment is controlled by monitoring and/or adjusting an aquatic variable selected from the group consisting of pH, salinity, dissolved oxygen, alkalinity, nutrient concentrations, water homogeneity, temperature, turbidity, algae culture, and fish stock.

18. A method of optimizing removal of carbon dioxide from water, said method comprising:
(i) converting the carbon dioxide in the water into algal biomass carbon;
(ii) converting the algal biomass carbon into fish biomass carbon; and
(iii) quantifying the fish biomass carbon of step (ii);
(iv) using the amount of fish biomass quantified in step (iii) to quantify the amount of carbon dioxide removed from the water;
wherein steps (i) and (ii) take place in an aquatic environment.

19. A method of creating tradable carbon credits, said method comprising:
(i) removing carbon dioxide from water;
(ii) producing biomass carbon from the carbon dioxide under conditions such that carbon credits are generated; and
(iii) transferring the resulting carbon credits to a third party.

20. The method of claim 19, wherein the method further comprises quantifying the biomass carbon produced from the carbon dioxide to calculate the carbon credits.

21. The method of claim 19, wherein the biomass carbon is produced by harvesting algae by fish that feed on the algae.
